(19) United States
(12) Patent Application Publication
(10) Pub. No.: US 2019/0011039 A1
(43) Pub. Date: Jan. 10, 2019

(54) PLANETARY GEAR MECHANISM

(71) Applicant: HONDA MOTOR CO., LTD., Tokyo (JP)

(72) Inventor: Satoshi Yugi, Wako-shi (JP)

(73) Assignee: HONDA MOTOR CO., LTD., Tokyo (JP)

(21) Appl. No.: 16/066,430

(22) PCT Filed: Dec. 27, 2016
(86) PCT No.: PCT/JP2016/088899

§ 371 Date: Jun. 27, 2018

(30) Foreign Application Priority Data
Dec. 28, 2015 (JP) 2015-256874

(51) Int. Cl. F16H 57/08; F16H 1/28; F16C 19/06

(52) U.S. Cl. CPC F16H 57/08; F16H 1/28; F16H 57/043; F16H 2057/085; F16H 2001/2881; F16C 19/06

(57) ABSTRACT

A planetary gear mechanism comprises a sun gear, a planetary gear that meshes with the sun gear, a planetary carrier having a planetary shaft which axially supports the planetary gear, and a ring gear which meshes with the planetary gear; wherein: the planetary gear has a coaxially disposed first inside-diameter part and second inside-diameter part of different inside diameter; the planetary gear mechanism has a first bearing member that has an outside diameter conforming to the first inside-diameter part and a second bearing member that has an outside diameter conforming to the second inside-diameter part, the two bearing members being arranged between the planetary shaft and the planetary gear; and the planetary gear mechanism is easily assembled while having a configuration in which the two bearing members are interposed between the planetary shaft and the planetary carrier so as to be coaxially divided in the axial direction.

### TECHNICAL FIELD

The present invention relates to a planetary gear mechanism.

### BACKGROUND ART

Generally, a planetary gear mechanism has a sun gear, a planetary gear that meshes with this sun gear, a planetary carrier having a planetary shaft which pivotally supports this planetary gear, and a ring gear that meshes with this planetary gear. Such a planetary gear mechanism, for example, is applied to the driving-force transmission system of a vehicle (for example, refer to Patent Document 1).

Patent Document 1: Japanese Unexamined Patent Application, Publication No. 2013-137073

### DISCLOSURE OF THE INVENTION

### Problems to be Solved by the Invention

In a planetary gear mechanism, the planetary gear is pivotally supported by a planetary shaft via a bearing member such as a needle bearing, for example. In the case of the dimension in the axial direction of the planetary gear being relatively large, a bearing member made to handle this also becomes necessary. With the planetary gear mechanism disclosed in Patent Document 1, the bearing member is not made as a single unit that is long in the axial-direction dimension, but rather a configuration applying two bearing members divided coaxially in the axial direction is adopted. In the case of Patent Document 1, by a collar being interposed between two bearing members, and using a plurality of bearing members which individually have relatively short axial dimensions, it is configured so that the planetary gear having a relatively long axial-dimension can be pivotally supported.

However, special technology for a planetary gear mechanism that achieves an improvement in ease of assembly during manufacture while adopting a configuration interposing two bearing members separated coaxially in the axial direction, between the planetary shaft and the planetary gear as mentioned above has not been proposed.

The present invention has been made taking account of the aforementioned such situation, and has an object of providing a planetary gear mechanism having favorable ease of assembly, while adopting a configuration that interposes two bearing members separated coaxially in the axial direction, between a planetary shaft and planetary gear.

### Means for Solving the Problems

According to a first aspect of the present invention, a planetary gear mechanism includes: a sun gear (for example, the sun gear 10 described later); a planetary gear (for example, the planetary gear 20 described later) that meshes with the sun gear; a planetary carrier (for example, the planetary carrier 31 described later) having a planetary shaft (for example, the planetary shaft 30 described later) that pivotally supports the planetary gear; and a ring gear (for example, the ring gear 40 described later) that meshes with the planetary gear, in which the planetary gear coaxially has a first inside-diameter part (for example, the first inside-diameter part 201 described later) and a second inside-diameter part (for example, the second inside-diameter part 202 described later) of different inside diameters, and the planetary gear mechanism includes, to be arranged between the planetary shaft and the planetary gear, a first bearing member (for example, the first bearing member 51 described later) having an outside diameter conforming to the first inside-diameter part; and a second bearing member (for example, the second bearing member 52 described later) having an outside diameter conforming to the second inside-diameter part.

With the planetary gear mechanism 1 of the first aspect, the outside diameter of the first bearing member conforms to the first inside-diameter part of the planetary gear, and the outside diameter of the second bearing member conforms to the second inside-diameter part of the planetary gear, and the inside diameters differ between the first inside-diameter part 201 and second inside-diameter part. For this reason, there is no risk of a mistake arising in the order of assembling the first bearing member and second bearing member. Therefore, mis-assembly is prevented, and the ease of assembly is favorable.

According to a second aspect of the present invention, in the planetary gear mechanism as described in the first aspect, the planetary gear has, between the first inside-diameter part and the second inside-diameter part, an inside-diameter stepped part (for example, the inside-diameter stepped part 203 described later) that has an inside diameter which changes to form a step.

With the planetary gear mechanism of the second aspect, in the planetary gear mechanism of the first aspect in particular, between the first inside-diameter part and second inside-diameter part, it has the inside-diameter stepped part for which the inside diameter changes to form a step. For this reason, the inside-diameter stepped part functions for positioning in the axial direction of the bearing member arranged between the planetary shaft and planetary gear (second bearing member 52 in the example described later), and the ease of assembly is favorable.

According to a third aspect of the present invention, in the planetary gear mechanism as described in the first or second aspect, the planetary shaft coaxially has a first outside-diameter part (for example, the first outside-diameter part 301 described later) and a second outside-diameter part (for example, the second outside-diameter part 302 described later) having different outside diameters.

With the planetary gear mechanism of the third aspect, in the planetary gear mechanism of either of the first or second aspect in particular, due to the outside diameter of the planetary shaft being different between the first outside-diameter part and second outside-diameter part, it is possible to establish the thickness dimension in the radial direction of the bearing member arranged between the planetary shaft and planetary gear as a constant dimension, in accordance with the difference between the inside diameter dimensions of the first inside-diameter part and second inside-diameter part of the planetary gear. Therefore, it is possible to adopt a configuration in which a non-standard bearing member is not required, and thus the ease of assembly is favorable.

According to a fourth aspect of the present invention, in the planetary gear mechanism as described in the third aspect, planetary shaft has, between the first outside-diameter part and the second outside-diameter part, an outside diameter stepped part (for example, the outside-diameter stepped part 303 described later) that has an outside diameter which changes to form a step.

With the planetary gear mechanism of the fourth aspect, in the planetary gear mechanism of third aspect in particular, the planetary shaft has, between the first outside-diameter part and second outside-diameter part, the outside diameter stepped part in which the outside diameter changes to form a step. For this reason, the outside diameter stepped part functions for positioning in the axial direction of the bearing member (first bearing member 51 in the example described later) arranged between the planetary shaft and planetary gear, and thus the ease of assembly is favorable.

According to the fifth aspect of the present invention, in the planetary gear mechanism as described in any one of the first to fourth aspects, a first gear part (for example, the first gear part 21 described later) and a second gear part (for example, the second gear part 22 described later) partitioned in the axial direction are arranged coaxially at an outer circumference of the planetary gear.

With the planetary gear mechanism of the fifth aspect, in the planetary gear mechanism of any one of the first to fourth aspects in particular, the first gear part and second gear part are arranged on the outer circumference of the planetary gear so as to be partitioned in the axial direction coaxially. For this reason, it is possible to adopt a mode performing transfer of torque at a reduction ratio as required at a position separated in the axial direction by the planetary gear, and possible to configure compactly; therefore, the ease of assembly is favorable.

According to a sixth aspect of the present invention, in the planetary gear mechanism as described in the fifth aspect, the planetary gear has different outside diameters at the first gear part and the second gear part.

With the planetary gear mechanism of the sixth aspect, in the planetary gear mechanism of the fifth aspect in particular, due to the outside diameters of the first gear part and second gear part differing, the planetary gear can adopt a form that performs transfer of torque with gear reduction at the planetary gear itself, and it is possible to configure compactly; therefore, the ease of assembly is favorable.

According to a seventh aspect of the present invention, the planetary gear mechanism as described in any one of the first to sixth aspects, further includes: an annular member (for example, the collar 53 described later) inserted between the first bearing member and the second bearing member.

With the planetary gear mechanism of the seventh aspect, in the planetary gear mechanism of any one of the first to sixth aspects in particular, since the annular member is inserted between the first bearing member and second bearing member, it is possible to increase the distance between support points from one end side to the other end side as a bearing member combining the first bearing member and second bearing member; therefore, it is possible to improve the durability as a bearing member.

According to an eighth aspect of the present invention, in the planetary gear mechanism as described in the seventh aspect, the annular member has an outside diameter larger than one (for example, the first bearing member 51 described later) among the first bearing member and the second member having a smaller outside diameter.

With the planetary gear mechanism of the eighth aspects, in the planetary gear mechanism of the seventh aspect in particular, the annular member has an outside diameter larger than the bearing member among the first bearing member and second bearing member having a smaller outside diameter; therefore, the annular member and bearing member are easily identified from the difference in outside diameter, and the risk of mis-assembly is effectively avoided.

According to a ninth aspect of the present invention, in the planetary gear mechanism as described in the seventh aspect, the annular member has an outside diameter that is substantially equal to one (for example, the second bearing member 52 described later) among the first bearing member and the second member having a larger outside diameter.

With the planetary gear mechanism of the ninth aspect, in the planetary gear mechanism of the seventh aspect in particular, since the annular member has a substantially equal outside diameter to the bearing member among the first bearing member and second bearing member having the larger outside diameter, it is possible to adopt a form fitting the annular member and bearing member having the larger outside diameter in the same inside-diameter part of the planetary gear (second inside-diameter part 202 in the example described later), and it is possible to configure compactly; therefore, the ease of assembly is favorable.

According to a tenth aspect of the present invention, in the planetary gear mechanism as described in the sixth aspect, in the planetary gear, the inside diameter of the first inside-diameter part is smaller diameter than the inside diameter of the second inside-diameter part, the outside diameter of the first gear part is larger diameter than the outside diameter of the second gear part, the first inside-diameter part and first gear part assume a positional relationship overlapping in the axial direction of the planetary shaft, and the second inside-diameter part and the second gear part assume a positional relationship overlapping in the axial direction of the planetary shaft.

With the planetary gear mechanism of the tenth aspect, in the planetary gear mechanism of the sixth aspect in particular, each site at the inside-diameter part of the planetary gear assumes a dimensional relation as described above; therefore, the pivotally supported portion of the first gear part that is at a relatively leading end side of the planetary shaft and to which a great external force in a falling direction acts becomes relatively thick. For this reason, it is possible to effectively suppress the risk of damage.

According to an eleventh aspect of the present invention, in the planetary gear mechanism as described in the third aspect, in the planetary gear, the inside diameter of the first inside-diameter part is smaller diameter than the inside diameter of the second inside-diameter part; in the planetary shaft, the outside diameter of the first outside-diameter part is smaller diameter than the outside diameter of the second outside-diameter part; and in a state assembling the planetary gear and the planetary shaft, the first inside-diameter part of the planetary gear and the first outside-diameter part of the planetary shaft assume a positional relationship overlapping in the axial direction of the planetary shaft, and the second inside-diameter part of the planetary gear and the second outside-diameter part of the planetary shaft assume a positional relationship overlapping in the axial direction of the planetary shaft.

With the planetary gear mechanism of the eleventh aspect, in the planetary gear mechanism of the third aspect in particular, since each site of the inside-diameter part of the planetary gear and each site of the outside-diameter part of the planetary shaft assume a dimensional relationship as mentioned above, the bearing fitting space (interval in radial direction) between the inside diameter of the planetary gear and the outside diameter of the planetary shaft has little difference at sites differing in position in the axial direction. For this reason, the size of the rolling elements of the bearing will not greatly differ, and tend to adapt to standardization of assembly components.

According to an twelfth aspect of the present invention, the planetary gear mechanism as described in the eleventh aspect further includes: an annular member (for example, the collar 53 described later) inserted between the first bearing member and the second bearing member, in which both of the second inside-diameter part of the planetary gear and the first outside-diameter part of the planetary shaft assume a positional relationship overlapping in the axial direction of the planetary shaft, in a state assembling the planetary gear and the planetary shaft, in which the outside diameter of the annular member is larger than the inside diameter of the first inside-diameter part of the planetary gear, and is substantially equal to or smaller than the inside diameter of the second inside-diameter part of the planetary gear; and the inside diameter of the annular member is substantially equal to or larger than the outside diameter of the first outside-diameter part of the planetary shaft, and is smaller than the outside diameter of the second outside-diameter part of the planetary shaft.

With the planetary gear mechanism of the twelfth aspect, in the planetary gear mechanism of the eleventh aspect in particular, the annular member is fit at the above-mentioned such specific location between the first bearing member and the second bearing member. For this reason, between a shoulder of the inside diameter step part (for example, the inside-diameter stepped part 203 described later) formed on the inside diameter side of the planetary gear, and a shoulder of the outside-diameter stepped part (for example, the outside-diameter stepped part 303 described later) formed at the outside diameter side of the planetary shaft, the annular member is sandwiched, whereby it is possible to positionally restrict.

According to a thirteenth aspect of the present invention, in the planetary gear mechanism as described in the eleventh or twelfth aspect, the inside diameter of the first inside-diameter part of the planetary gear is larger than the outside diameter of the second outside-diameter part of the planetary shaft.

With the planetary gear mechanism of the thirteenth aspect, in the planetary gear mechanism of the eleventh or twelfth aspect in particular, since the inside diameter of the first inside-diameter part of the planetary gear is larger than the outside diameter of the second outside-diameter part of the planetary shaft, the bearing fitting space (interval in radial direction) between the inside diameter of the planetary gear and the outside diameter of the planetary shaft has little difference at sites differing in position in the axial direction. For this reason, the size of the rolling elements of the bearing will not greatly differ, and tend to adapt to standardization of assembly components.

### Effects of the Invention

According to the present invention, it is possible to provide a planetary gear mechanism having favorable ease of assembly, while adopting a configuration that interposes two bearing members separated coaxially in the axial direction, between a planetary shaft and planetary gear.

### BRIEF DESCRIPTION OF THE DRAWINGS

FIG. 1 is a longitudinal section view showing a planetary gear mechanism as one embodiment of the present invention;

FIG. 2 is a longitudinal section view of principle parts showing one modified example of the embodiment in FIG. 1;

FIG. 3 is a longitudinal section view of principle parts showing another modified example of the embodiment in FIG. 1;

FIG. 4 is a longitudinal section view of principle parts showing another modified example of the embodiment in FIG. 1; and

FIG. 5 is a longitudinal section view of principle parts showing another modified example of the embodiment in FIG. 1.

### PREFERRED MODE FOR CARRYING OUT THE INVENTION

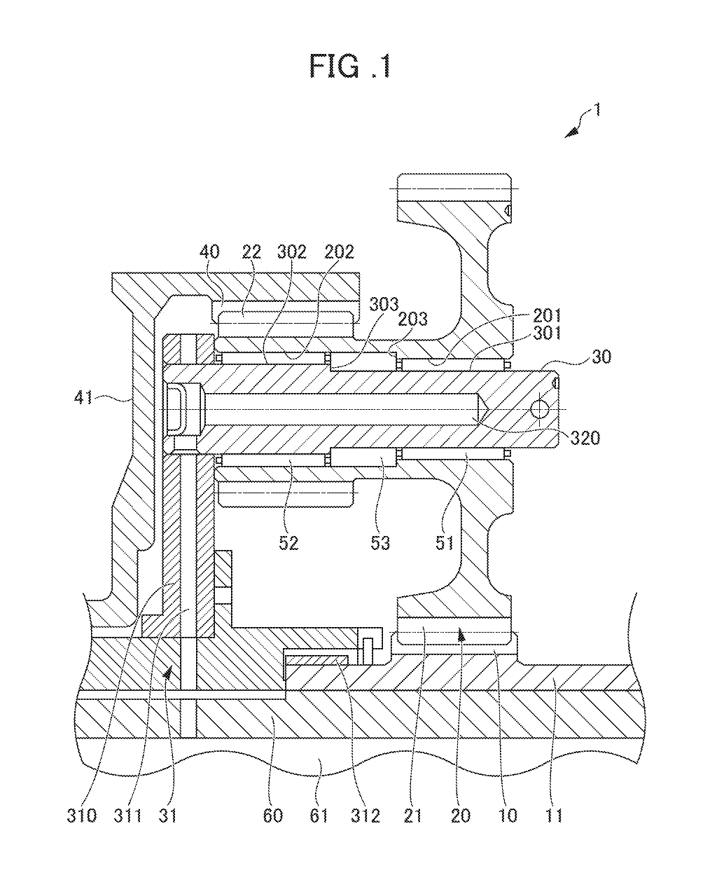

FIG. 1 is a longitudinal section view showing a planetary gear mechanism as one embodiment of the present invention. This planetary gear mechanism 1 has a sun gear 10, a planetary gear 20 that meshes with this sun gear 10, a planetary carrier 31 having a planetary shaft 30 that pivotally supports the planetary gear 20, and a ring gear 40 that meshes with the planetary gear 20. The sun gear 10 is formed on an input shaft 11 that revolves to transfer the rotational driving force from the drive source (not illustrated). An output shaft 60 is provided coaxially on the inside diameter side of the input shaft 11.

In addition, the planetary carrier 31 makes a form in which an arm 310 extends radially from a substantially cylindrical base provided coaxially on the outer circumferential side of the output shaft 60 and to be relative displaceable via a bearing 312 from the input shaft 11. Then, at a leading end vicinity site of the arm 310, the planetary shaft 30 is provided so that the axis line direction of itself becomes parallel with the axis line direction of the output shaft 60. The arm 310 in the present example cantilever supports the planetary shaft 30. Furthermore, the ring gear 40 is supported by a coupling part 41 having a portion that extends in the radial direction relative to the axis of the input shaft 11 and output shaft 60.

It should be noted that, an output shaft internal lubricating oil path 61 is formed in the axial direction inside of the output shaft 60, an arm internal lubricating oil path 311 is formed inside of the arm 310, and a planetary shaft internal lubricating oil path 320 is formed within the planetary shaft 30. With the planetary gear mechanism 1 of the present embodiment, for the planetary gear 20, a plurality of the same specification are provided, and planetary shafts 30 are also equipped in plurality to correspond to the respective planetary gears 20; however, in FIG. 1, one planetary gear 20 and the planetary shaft 30 corresponding to this are shown representatively.

The planetary gear 20 coaxially has a first inside-diameter part 201 and second inside-diameter part 202 of different inside diameters, and further has, between the first inside-diameter part 201 and second inside-diameter part 202, an inside-diameter stepped part 203 in which the inside diameter changes relative to the position in the axial direction to form a step. As in the illustration, with the planetary gear 20 of the present example, the inside diameter of the first inside-diameter part 201 is relatively small diameter, and the inside diameter of the second inside-diameter part 202 is relatively large diameter. In addition, the planetary gear 20 is arranged so that a site at which the second inside-diameter part 202 thereof is formed is at a side of the arm 310.

In addition, between the planetary shaft 30 and planetary gear 20, a first bearing member 51 having an outside diameter adapted to the first inside-diameter part 201 of the planetary gear 20, and a second bearing member 52 having an outside diameter adapted to the second inside-diameter part 202 are provided to be alienated in the axial direction. The first bearing member 51 and second bearing member 52 are needle bearings as the rolling element, for example, and conform to the shape of aforementioned such inside diameter of the planetary gear 20, with the outside diameter of the first bearing member 51 being relatively small diameter and the outside diameter of the second bearing member 52 being relatively large.

Herein, the outside diameter for the first bearing member 51 and second bearing member 52 is the outside diameter dimension of the outer ring. So long as making the outside diameter larger, since it is possible to widen the PCD (Pitch Circle Diameter), and thus increase the number of rollers and radius dimension as the rolling element, it advantageous at the transfer site of high torque. In the case of the present example, the second bearing member 52 has larger PCD than the first bearing member 51, and serves well as the bearing member at the transfer site of high torque.

On the other hand, the planetary shaft 30 coaxially has the first outside-diameter part 301 and second outside-diameter part 302 of different outside diameters, and further has, between the first outside-diameter part 301 and second outside-diameter part 302, an outside-diameter stepped part 303 at which the outside diameter changes relative to position in the axial direction to form a step. As in the illustration, in the present example, the outside diameter of the first outside-diameter part 301 is relatively small diameter, and the outside diameter of the second outside-diameter part 302 is relatively large diameter. In addition, the planetary shaft 30 is arranged so that a site at which the second outside-diameter part 302 thereof is formed is at a side of the arm 310.

In the planetary gear 20 in FIG. 1, a first gear part 21 and second gear part 22 partitioned in the axial direction are arranged coaxially, and the outside diameters differ between the first gear part 21 and second gear part 22. In other words, the planetary gear 20 constitutes a so-called double planetary gear (double pinion gear) in which the first gear part 21 is relatively large diameter, and the second gear part 22 is small diameter. In addition, the planetary gear 20 is arranged so that the side of the second gear part 22 thereof comes to be at a side of the arm 310. In addition, a collar 53 that is an annular member is inserted between the first bearing member 51 and second bearing member 52 of the planetary shaft 30. As already mentioned, the outside diameter of the first bearing member 51 is relatively small diameter, and the outside diameter of the second bearing member 52 is relatively large diameter. As in the illustration, the collar 53 has an outside diameter larger than the outside diameter of the first bearing member 51, and has an outside diameter substantially equal to the outside diameter of the second bearing member 52. It should be noted that, in the example of FIG. 1, the inside diameter of the first inside-diameter part 201 of the planetary gear 20 is larger than the outside diameter of the second outside-diameter part 302 of the planetary shaft 30.

With the aforementioned planetary gear mechanism 1, when rotational driving force from the drive source (not illustrated) is inputted from the input shaft 11 and the sun gear 10 rotates, the rotation which was gear reduced via the first gear part 21 of the planetary gear 20 meshing with the sun gear 10 and the second gear part 22 of the planetary gear 20 is outputted to the output shaft 60 via the planetary carrier 31. In other words, higher torque will be transferred in the second gear part 22 of relatively smaller diameter than the side of the first gear part 21 of relatively large diameter of the planetary gear 20.

A portion of the planetary shaft 30 corresponding to the second gear part 22 is the second outside-diameter part 302, and this portion is a larger diameter than the first outside-diameter part 301 by the step amount of the outside-diameter stepped part 303; therefore, it serves well as a spindle of the high torque transfer part. In addition, between the planetary shaft 30 and planetary gear 20, the first bearing member 51 and second bearing member 52 are interposed; however, the second bearing member 52 having an outside diameter that conforms to the second inside-diameter part 202 of relatively large diameter tends to have larger PCD. Therefore, the second bearing member 52 tends to adopt a bearing of large volume as the bearing, and it is possible to establish a bearing superior in durability suited for use at the site immediately below the second gear part 22 to which high torque is transferred.

Furthermore, the bearing members between the planetary shaft 30 and planetary gear 20 are a configuration in which the first bearing member 51 and second bearing member 52 are aligned coaxially in series, and the collar 53 is inserted between the first bearing member 51 and second bearing member 52. Therefore, the bearing member between the planetary shaft 30 and planetary gear 20 excel in durability as bearing members due to being able to increase the distance between support points from one end side to the other end side as a bearing member combining the first bearing member 51 and second bearing member 52.

As already mentioned, as bearing members, a configuration is already known that applies two bearing members divided coaxially in the axial direction, interposes a collar between both bearing members, and uses two bearing members of the same specification which are relatively short relative to one collar, thereby securing the distance between the support points in the case of pivotally supporting a planetary gear. However, a problem arises in the ease of assembly in the case of simply configuring in this way. In other words, generally, in a portion pivotally supporting the planetary gear by the planetary shaft, the outside diameter of the planetary shaft and the inside diameter of the planetary gear are constant along substantially the entire length in the axial direction. In the work of inserting two relatively short bearing members of the same specification and one collar between such a planetary shaft and planetary gear, the two bearing members and one collar are simply insertable without regard to the insertion order thereof. Therefore, properly speaking, since these bearing members and the collar should be inserted in a sequence such that one collar is positioned between two bearing members, there is a risk of mis-assembly being permitted in a sequence such that one collar is positioned on an end side.

In contrast, in the case of the embodiment of FIG. 1, at the inside diameter of the planetary gear 20, the second inside-diameter part 202 is larger diameter than the first inside-diameter part 201, and corresponding thereto, the outside diameter of the second bearing member 52 is larger than the outside diameter of the first bearing member 51. For this reason, the risk of mistakes arising in the assembly sequence of the first bearing member 51 and second bearing member 52 is reduced. Therefore, mis-assembly is prevented and ease of assemble is favorable. In particular, in the embodiment of FIG. 1, the first bearing member 51 and second bearing member 52 only fall into legitimate positions, and inserting in a state mistaking the assembly sequence is not possible in principle.

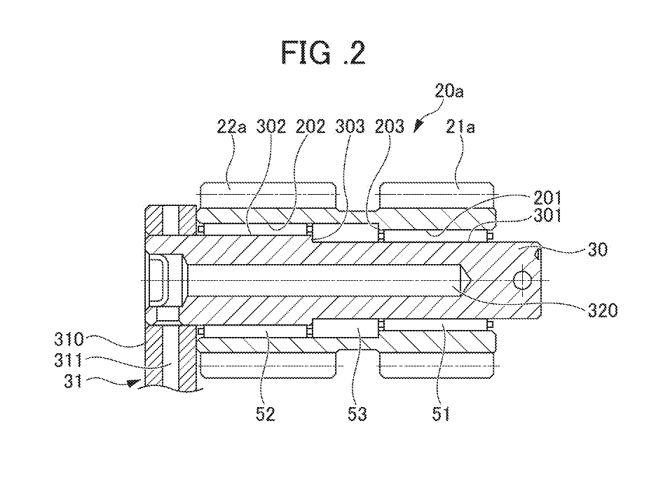

Furthermore, the collar 53 which is an annular member is arranged by configuring so as to restrict the position in the axial direction between the inside-diameter stepped part 203 at the inside diameter of the planetary gear 20 and the outside-diameter stepped part 303 at the outside diameter of the planetary shaft 30. More generally speaking, the collar 53 that is an annular member has an outside diameter that is larger than the bearing member having a smaller outside diameter among the first bearing member 51 and second bearing member 52. For this reason, the collar 53 that is an annular member and the bearing member (first bearing member 51 in the example of FIG. 1) are easily identified due to the difference in outside diameter, and the risk of mis-assembly is effectively avoided. In addition, the collar 53 that is an annular member has an outside diameter substantially equal to the bearing member having a larger outside diameter among the first bearing member 51 and second bearing member 52 (second bearing member 52 in example of FIG. 1); therefore, it is possible to adopt a mode fitting the collar 53 that is an annular member and the second bearing member 52 at the same inside-diameter part of the planetary gear 20 (second inside-diameter part 202 in example of FIG. 2), and since it is possible to configure compactly, the ease of assembly is favorable.

In the case of the present example, as the collar 53, one having a thickness dimension in the radial direction that is larger than both bearing members 51 and 52 is applied. For this reason, the collar 53 only fits at a legitimate position, and insertion in a state mistaking the assembly sequence is not possible in principle. For this reason, with the planetary gear mechanism 1 of the present embodiment, there is no margin whereby the aforementioned such mis-assembly could occur. Therefore, mis-assembly is essentially prevented.

In addition, with the planetary gear mechanism 1 of the present embodiment, the collar 53, which is an annular member, is fit between the inside-diameter stepped part 203 and outside-diameter stepped part 303 which are formed at the inside diameter of the planetary gear 20 and outside diameter of the planetary shaft 30, as mentioned above. For this reason, the appropriate position regulation in the axial direction of the collar 53 is carried out, and accompanying this, appropriate position regulation in the axial direction of the first bearing member 51 and second bearing member 52 is carried out. Therefore, the ease of assembly is favorable.

Furthermore, for the planetary gear mechanism 1 of FIG. 1, it is possible to exemplify the following points regarding the ease of assembly being favorable. Specifically, since the outside diameter of the planetary shaft 30 differs at the first outside-diameter part 301 and second outside-diameter part 302, it is possible to establish the thickness dimension in the radial direction of the bearing members (first bearing member 51 and second bearing member 52) arranged between the planetary shaft 30 and planetary gear 20, as a constant dimension, in accordance with the difference between the inside diameter dimensions of the first inside-diameter part 201 and second inside-diameter part 202 of the planetary gear 20. Therefore, a configuration in which a non-standard bearing member is not required can be adopted, and thus the ease of assembly is favorable.

In addition, since the planetary gear 20 is arranged by configuring so that the first gear part 21 and second gear part 22 are partitioned in the axial direction coaxially, it is possible to adopt a mode performing transfer of torque at a reduction ratio according to the need, at a position separated in the axial direction by the planetary gear 20, and can be configured compactly; therefore, the ease of assembly is favorable.

In addition, with the planetary gear 20, since the outside diameters differ between the first gear part 21 and second gear part 22, it is possible to adopt a mode performing transfer of torque with a reduction ratio by the planetary gear 20 itself. For this reason, since the planetary gear mechanism 1 can be configured compactly, the ease of assembly is favorable.

It should be noted that, upon producing the inside diameter of the planetary gear 20 in a shape having the aforementioned such inside-diameter stepped part 203, it is possible to produce in by one-time setup machining by applying a dedicating stepped drill. In addition, if the increase (decrease) in diameter dimension is on the order of 2 mm for the inside-diameter stepped part 203 and outside-diameter stepped part 303, there will be a sufficient effect in the aforementioned mis-assembly prevention.

Furthermore, in the example of FIG. 1, the inside diameter of the first inside-diameter part 201 of the planetary gear 20 is larger than the outside diameter of the second outside-diameter part 302 of the planetary shaft 30. For this reason, the bearing fitting space (interval in radial direction) between the inside diameter of the planetary gear 20 and outside diameter of planetary shaft 30 has little variation in tolerance at different positions in the axial direction. Therefore, the size of the rolling element in the bearing applied will not greatly differ, and tends to adapt to standardization of assembly components.

FIG. 2 is a longitudinal section view of principle parts showing one modified example of the embodiment in FIG. 1. In FIG. 2, the same reference symbol is attached and illustrated for corresponding parts of FIG. 1, and individual detailed explanations will be omitted. The modified example of FIG. 2 differs in the point of the first gear part 21 being relatively large diameter and the second gear part 22 being small diameter in the planetary gear 20 of the embodiment in FIG. 1; whereas, the outside diameters of the first gear part 21a and second gear part 22a of the planetary gear 20a are the same. Therefore, the planetary gear 20 in FIG. 1 is a so-called double planetary gear having a reduction function in itself; whereas, the planetary gear 20a in this modified example of FIG. 2 transfers the inputted rotational driving force to the ring gear (not illustrated) without reduction by itself. In this case, the ring gear is of a dimension and arrangement conforming to the second gear part 22a of the planetary gear 20a.

Also in the modified example of FIG. 2, the inner circumferential side of the planetary gear 20a is formed in substantially the same way as the planetary gear 20 of the embodiment in FIG. 1. In other words, it has the first inside-diameter part 201 with a relatively small inside diameter and the second inside-diameter part 202 with a relatively large inside diameter, and between the inside-diameter parts of different inside diameter dimension, has the inside-diameter stepped part 203. In addition, the planetary shaft 30 coaxially has the first outside-diameter part 301 of relatively small outside diameter and the second outside-diameter part 302 of relatively large outside diameter, and further has, between the first outside-diameter part 301 and second outside-diameter part 302, the outside-diameter stepped part 303 in which the outside diameter changes relative to the position in the axial direction to form a step.

Between the planetary gear 20a and planetary shaft 30, the first bearing member 51 and second bearing member 52 are provided in the same mode as the example in FIG. 1. The first bearing member 51 has an outside diameter conforming to the first inside-diameter part 201 of the planetary gear 20, and the second bearing member 52 has an outside diameter conforming to the second inside-diameter part 202 of the planetary gear 20. The outside diameter of the first bearing member 51 is relatively small diameter, and the outside diameter of the second bearing member 52 is relatively large diameter, to conform to the shape of the aforementioned inside diameter of the planetary gear 20. Therefore, also in the modified example of FIG. 2, the first bearing member 51 and second bearing member 52 only fit at legitimate positions, respectively, and inserting in a state mistaking the assembly sequence is not possible in principle, and thus there is no margin whereby mis-assembly could occur.

Similarly to the example of FIG. 1, the collar 53 that is an annular member is inserted between the first bearing member 51 and second bearing member 52, to be positioned in a space between the inside-diameter stepped part 203 of the planetary gear 20a and the outside-diameter stepped part 303 of the planetary shaft 30, and the thickness dimension in the radial direction thereof is larger than both bearing members 51 and 52. For this reason, the collar 53 also only fits at the legitimate position, and inserting in a state mistaking the assembly sequence is not possible in principle. Therefore, with the planetary gear mechanism 1 of the present embodiment, there is no margin whereby the aforementioned such mis-assembly could occur. Therefore, mis-assembly is essentially prevented. It should be noted that, as already mentioned, since the collar 53 which is an annular member fits between the inside-diameter stepped part 203 and outside-diameter stepped part 303 formed in the inside diameter of the planetary gear 20 and outer side of the planetary shaft 30, the appropriate position regulation in the axial direction of the collar 53 is carried out.

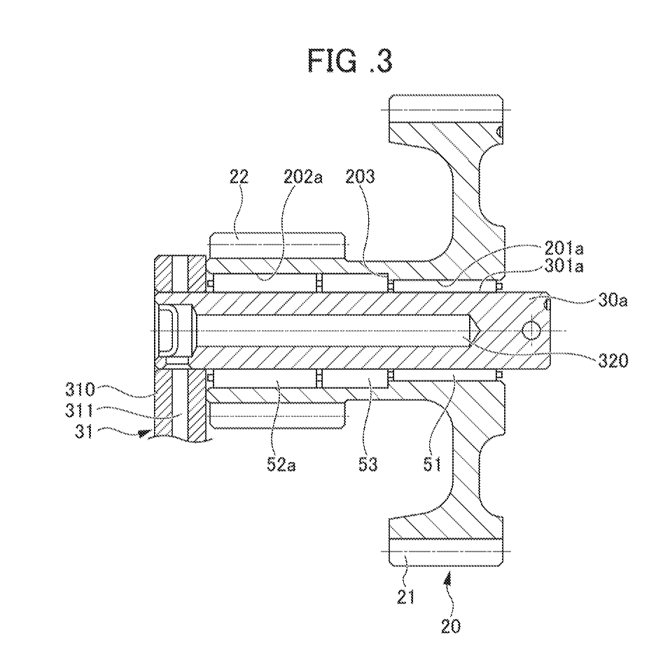

FIG. 3 is a longitudinal section view of principle parts showing one modified example of the embodiment in FIG. 1. In FIG. 3, the same reference symbol is attached and illustrated for corresponding parts of FIG. 1, and individual detailed explanations will be omitted. In the modified example of FIG. 3, the planetary shaft 30a does not have an outside-diameter stepped part 303 as in the planetary shaft 30 of the example in FIG. 1, and rather has an outside-diameter part 301a for which the outside diameter is constant along substantially the entire length in the axial direction. The planetary shaft 30a differs from the planetary shaft 30 of FIG. 1 as mentioned above; however, the planetary gear 20 is the same as the example of FIG. 1. For this reason, the interval in the radial direction between the second inside-diameter part 202 of the planetary gear 20 and the outside-diameter part 301a of the planetary shaft 30a is wider than the interval in the radial direction between the second inside-diameter part 202 and second outside-diameter part 302 of the example in FIG. 1, and is substantially equal to the interval in the radial direction between the second inside-diameter part 202 and the first outside-diameter part 301 at the site where the collar 53 is arranged.

In contrast, for the first bearing member 51 and second bearing member 52a provided between the planetary gear 20 and planetary shaft 30a, the second bearing member 52a is relatively larger in the thickness dimension in the radial direction. In other words, for the second bearing member 52a of the present example, a bearing member that is larger than the second bearing member 52 in FIG. 1 for either the outside diameter dimension and thickness dimension in the radial direction, is applied. Therefore, in the example of FIG. 3, the first bearing member 51 and second bearing member 52a only fit at legitimate positions, and inserting in a state mistaking the assembly sequence is not possible in principle, and thus there is no margin whereby mis-assembly could arise.

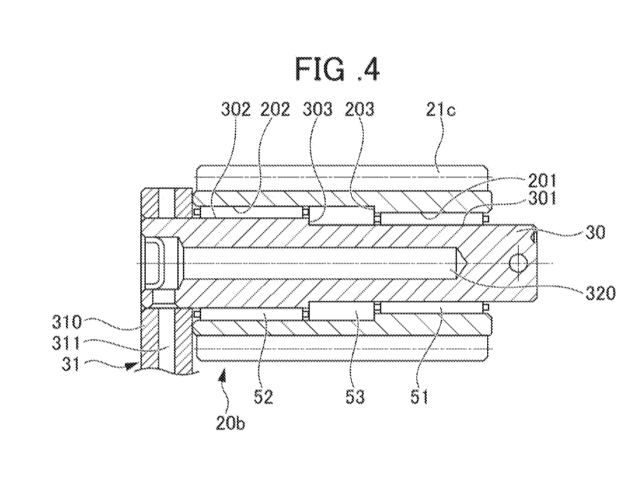

FIG. 4 is a longitudinal section view of principle parts showing one modified example of the embodiment in FIG. 1. In FIG. 4, the same reference symbols are attached and shown for corresponding parts with FIG. 1 and FIG. 2, and individual detailed explanations will be omitted. As is easily understood by referencing FIG. 4 with the previously mentioned FIG. 2, although the planetary gear 20b in FIG. 4 and the planetary gear 20a in FIG. 2 are of different forms, they are substantially the same in other points. In other words, the planetary gear 20b in FIG. 4 has a single gear part 2c, and the gear part is not divided into a first gear part 21a and second gear part 22a as in the planetary gear 20a of FIG. 2. The functional effects in the example of FIG. 4 are substantially the same as those in FIG. 2 mentioned previously; therefore, the previously mentioned explanations related to FIG. 2 are invoked for this point.

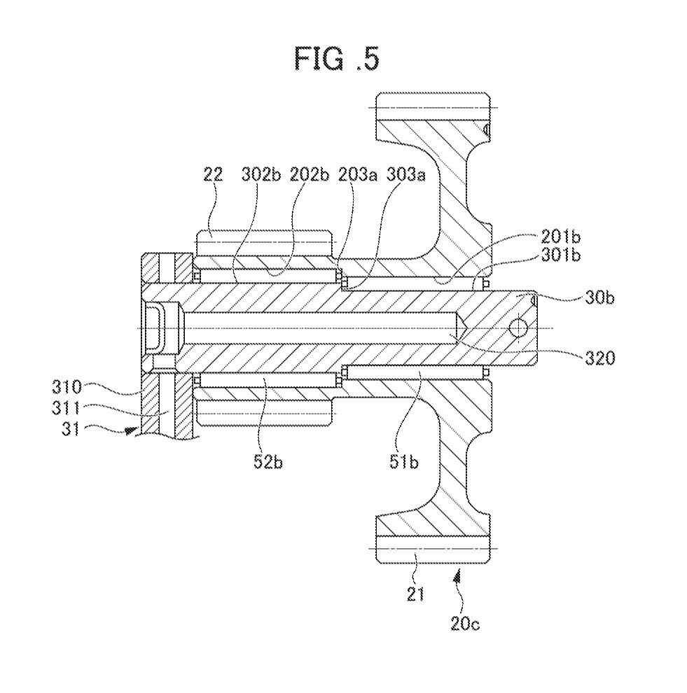

FIG. 5 is a longitudinal section view of principle parts showing one modified example of the embodiment in FIG. 1. In FIG. 5, the same reference symbol is attached and illustrated for corresponding parts of FIG. 1, and individual detailed explanations will be omitted. In the example of FIG. 5, a configuration is adopted not using the collar 53 as the annular member such as that in the examples of FIGS. 1 to 4. Therefore, the first bearing member 51b and second bearing member 52b adopt dimensions in which these are more or less extended to opposing sides in the axial direction, relative to the first bearing member 51 and second bearing member 52 in FIG. 1. In addition, for the planetary gear 20c, the first inside-diameter part 201a and second inside-diameter part 202b adopt dimensions in which these are respectively more or less extended to opposing sides in the axial direction, relative to the first inside-diameter part 201 and second inside-diameter part 202 in FIG. 1. Between this first inside-diameter part 201b and second inside-diameter part 202b, an inside-diameter stepped part 203a is formed.

Furthermore, for the planetary shaft 30b, the first outside-diameter part 30b and second outside-diameter part 302b adopt dimensions in which these are more or less extended to opposing sides in the axial direction, respectively, relative to the first outside-diameter part 301 and second outside-diameter part 302 in FIG. 1. Between this first outside-diameter part 301b and second outside-diameter part 302b, an outside-diameter stepped part 303a is formed.

Also in the example of FIG. 5, for the inside diameter of the planetary gear 20c, the second inside-diameter part 202b is larger diameter than the first inside-diameter part 201a, and corresponding thereto, the outside diameter of the second bearing member 52b is larger than the outside diameter of the first bearing member 51b. Therefore, the first bearing member 51b and second bearing member 52b only fit at legitimate positions, and inserting in a state mistaking the assembly sequence is not possible in principle. Furthermore, due to being a mode not using the collar which is an annular member, the problem of mis-assembly related to the collar will not arise in the first place.

The functional effects of the planetary gear mechanism of the present embodiment described above will be summarized. (1) With the planetary gear mechanism 1, the outside diameter of the first bearing member 51 conforms to the first inside-diameter part 201 of the planetary gear 20, and the outside diameter of the second bearing member 52 conforms to the second inside-diameter part 202 of the planetary gear 20, and the inside diameters differ between the first inside-diameter part 201 and second inside-diameter part 202. For this reason, there is no risk of a mistake arising in the order of assembling the first bearing member 51 and second bearing member 52. Therefore, mis-assembly is prevented, and the ease of assembly is favorable.

(2) With the planetary gear mechanism 1 in particular, between the first inside-diameter part 201 and second inside-diameter part 202, it has the inside-diameter stepped part 203 for which the inside diameter changes to form a step. For this reason, the inside-diameter stepped part 203 functions for positioning in the axial direction of the bearing member arranged between the planetary shaft 30 and planetary gear 20 (second bearing member 52 in aforementioned example), and the ease of assembly is favorable.

(3) With the planetary gear mechanism 1 in particular, due to the outside diameter of the planetary shaft 30 being different between the first outside-diameter part 301 and second outside-diameter part 302, it is possible to establish the thickness dimension in the radial direction of the bearing member (first bearing member 51, second bearing member 52) arranged between the planetary shaft 30 and planetary gear 20 as a constant dimension, in accordance with the difference between the inside diameter dimensions of the first inside-diameter part 201 and second inside-diameter part 202 of the planetary gear 20. Therefore, it is possible to adopt a configuration in which a non-standard bearing member is not required, and thus the ease of assembly is favorable.

(4) With the planetary gear mechanism 1 in particular, the planetary shaft 30 has, between the first outside-diameter part 301 and second outside-diameter part 302, the outside-diameter stepped part 303 in which the outside diameter changes to form a step. For this reason, the outside-diameter stepped part 303 functions for positioning in the axial direction of the bearing member (first bearing member 51 in aforementioned example) arranged between the planetary shaft 30 and planetary gear 20, and thus the ease of assembly is favorable.

(5) With the planetary gear mechanism 1 in particular, the first gear part 21 and second gear part 22 are arranged on the outer circumference of the planetary gear 20 so as to be partitioned in the axial direction coaxially. For this reason, it is possible to adopt a mode performing transfer of torque at a reduction ratio as required at a position separated in the axial direction by the planetary gear 20, and possible to configure compactly; therefore, the ease of assembly is favorable.

(6) With the planetary gear mechanism 1 in particular, due to the outside diameters of the first gear part 21 and second gear part 22 differing, the planetary gear 20 can adopt a form that performs transfer of torque with gear reduction at the planetary gear 20 itself, and it is possible to configure compactly; therefore, the ease of assembly is favorable.

(7) With the planetary gear mechanism 1 in particular, since the annular member 53 is inserted between the first bearing member 51 and second bearing member 52, it is possible to increase the distance between support points from one end side to the other end side as a bearing member combining the first bearing member 51 and second bearing member 52; therefore, it is possible to improve the durability as a bearing member.

(8) With the planetary gear mechanism 1 in particular, the annular member 53 has an outside diameter larger than the bearing member among the first bearing member 51 and second bearing member 52 having a smaller outside diameter (first bearing member 51 in aforementioned example); therefore, the annular member 53 and bearing member (first bearing member 51) are easily identified from the difference in outside diameter, and the risk of mis-assembly is effectively avoided.

(9) With the planetary gear mechanism 1 in particular, since the annular member 53 has a substantially equal outside diameter to the bearing member among the first bearing member 51 and second bearing member 52 having the larger outside diameter (second bearing member 52 in aforementioned example), it is possible to adopt a form fitting the annular member 53 and bearing member having the larger outside diameter (second bearing member 52) in the same inside-diameter part of the planetary gear 20 (second inside-diameter part 202 in aforementioned example), and it is possible to configure compactly; therefore, the ease of assembly is favorable.

(10) With the planetary gear mechanism 1 in particular, in the planetary gear 20, the inside diameter of the first inside-diameter part 201 is smaller diameter than the inside diameter of the second inside-diameter part 202, and the outside diameter of the first gear part 21 is larger diameter than the outside diameter of the second gear part 22, and the first inside-diameter part 201 and first gear part 21 assume in a positional relationship overlapping in the axial direction of the planetary shaft 30, and the second inside-diameter part 202 and second gear part 22 assume a positional relationship overlapping in the axial direction of the planetary shaft 30; therefore, the pivotally supported portion of the first gear part 21 that is at a relatively leading end side of the planetary shaft 30 and to which a great external force in a falling direction acts becomes relatively thick. For this reason, it is possible to effectively suppress the risk of damage.

(11) With the planetary gear mechanism 1 in particular, in the planetary gear 20, the inside diameter of the first inside-diameter part 201 is smaller diameter than the inside diameter of the second inside-diameter part 202; in the planetary shaft 30, the outside diameter of the first outside diameter 301 part is smaller diameter than the outside diameter of the second outside-diameter part 302; and in a state assembling the planetary gear 20 and the planetary shaft 30, the first inside-diameter part 201 of the planetary gear 20 and the first outside-diameter part 301 of the planetary shaft 30 assume a positional relationship overlapping in the axial direction of the planetary shaft 30, and the second inside-diameter part 202 of the planetary gear 20 and the second outside-diameter part 302 of the planetary shaft 30 assume a positional relationship overlapping in the axial direction of the planetary shaft 30; therefore, the bearing fitting space (interval in radial direction) between the inside diameter of the planetary gear 20 and the outside diameter of the planetary shaft 30 has little difference at sites differing in position in the axial direction. For this reason, the size of the rolling elements of the bearing will not greatly differ, and tend to adapt to standardization of assembly components.

(12) The planetary gear mechanism 1 in particular, further includes the annular member 53 inserted between the first bearing member 51 and second bearing member 52, in which both the second inside-diameter part 202 of the planetary gear 20 and the first outside-diameter part 301 of the planetary shaft 30 assume a positional relationship overlapping in the axial direction of the planetary shaft 30 in a state assembling the planetary gear 20 and planetary shaft 30, in which the outside diameter of the annular member 53 is larger than the inside diameter of the first inside-diameter part 201 of the planetary gear 20 and substantially equal to or smaller than the inside diameter of the second inside-diameter part 202 of the planetary gear 20, and further, the inside diameter of the annular member 53 is substantially equal to or larger than the outside diameter of the first outside-diameter part 301 of the planetary shaft 30 and smaller than the outside diameter of the second outside-diameter part 302 of the planetary shaft 30. For this reason, between a shoulder of the inside-diameter stepped part 203 formed on the inside diameter side of the planetary gear 20, and a shoulder of the outside-diameter stepped part 303 formed at the outside diameter side of the planetary shaft 30, the annular member 53 is sandwiched, whereby it is possible to positionally restrict.

With the planetary gear mechanism 1, in particular, since the inside diameter of the first inside-diameter part 201 of the planetary gear 20 is larger than the outside diameter of the second outside-diameter part 302 of the planetary shaft 30, the bearing fitting space (interval in radial direction) between the inside diameter of the planetary gear 20 and the outside diameter of the planetary shaft 30 has little difference at sites differing in position in the axial direction. For this reason, the size of the rolling elements of the bearing tends to fit into standardization of assembly members, without greatly differing.

Any of the modified examples explained by referencing FIGS. 2 to 5 above, a planetary gear mechanism having good assembly property for which the concern of producing mis-assembly of the bearing member is eliminated is provided. It should be noted that the present invention can be practiced by various making modifications and changes other than the aforementioned form. In the aforementioned respective examples, a configuration is adopted in which a portion at which the inside diameter of the pinion gear is relatively large diameter and a portion at which the outside diameter of the planetary shift is relatively large diameter correspond. In this case, a portion at which the inside diameter of the pinion gear is relatively small diameter, and a portion in which the outside diameter of the planetary shaft is relatively small diameter are corresponding. However, it is not limited to this form, and it is also possible to adopt a configuration in which the portion at which the inside diameter of the pinion gear is relative large diameter, and the portion at which the outside diameter of the planetary shaft is relatively small diameter correspond. In this case, the applied two bearing members have very larger difference in radial dimension, and the effect of mis-assembly prevention is remarkable. In addition, the bearing member is not limited to the form applying needle bearings as the rolling elements, and may be a member applying other rolling elements, for example, ball bearings.

### EXPLANATION OF REFERENCE NUMERALS

1 planetary gear mechanism
10 sun gear
20 planetary gear
21 first gear part
22 second gear part
30 planetary shaft
31 planetary carrier
40 ring gear
51 first bearing member
52 second bearing member
53 collar (annular member)
201 first inside-diameter part
202 second inside-diameter part
203 inside-diameter stepped part
301 first outside-diameter part
302 second outside-diameter part
303 outside-diameter stepped part

1-13. (canceled)

14. A planetary gear mechanism comprising:
a sun gear;
a planetary gear that meshes with the sun gear;
a planetary carrier having a planetary shaft that pivotally supports the planetary gear; and
a ring gear that meshes with the planetary gear,
wherein the planetary gear
coaxially has a first inside-diameter part and a second inside-diameter part of different inside diameters,
wherein the inside diameter of the first inside-diameter part is a smaller diameter than the inside diameter of the second inside-diameter part,
wherein the planetary shaft coaxially has a first outside-diameter part and a second outside-diameter part of different outside diameters,
wherein the outside diameter of the first outside-diameter part is smaller diameter than the outside diameter of the second outside-diameter part,
wherein the planetary gear mechanism comprises, to be arranged between the planetary shaft and the planetary gear,
a first bearing member having an outside diameter conforming to the first inside-diameter part, and a second bearing member having an outside diameter conforming to the second inside-diameter part, and
further comprises an annular member inserted between the first bearing member and the second bearing member,
wherein the annular member has
an outside diameter larger than one among the first bearing member and the second member having a smaller outside diameter, and
in a state assembling the planetary gear and the planetary shaft,
both of the second inside-diameter part of the planetary gear and the first outside-diameter part of the planetary shaft assume a positional relationship overlapping in an axial direction of the planetary shaft.

15. A planetary gear mechanism comprising:
a sun gear;
a planetary gear that meshes with the sun gear;
a planetary carrier having a planetary shaft that pivotally supports the planetary gear; and
a ring gear that meshes with the planetary gear,
wherein the planetary gear
coaxially has a first inside-diameter part and a second inside-diameter part of different inside diameters,
wherein the inside diameter of the first inside-diameter part is a smaller diameter than the inside diameter of the second inside-diameter part, and
comprises, to be arranged between the planetary shaft and the planetary gear,
a first bearing member having an outside diameter conforming to the first inside-diameter part, and a second bearing member having an outside diameter conforming to the second inside-diameter part,
wherein a first gear part and a second gear part partitioned in the axial direction are arranged coaxially at an outer circumference of the planetary gear,
wherein the outside diameter of the first gear part is larger diameter than the outside diameter of the second gear part,
wherein the first inside-diameter part and the first gear part assume a positional relationship overlapping in the axial direction of the planetary shaft, and
wherein the second inside-diameter part and the second gear part assume a positional relationship overlapping in the axial direction of the planetary shaft.

16. The planetary gear mechanism according to claim 15, wherein the planetary shaft coaxially has a first outside-diameter part and a second-outside diameter part having different outside diameters.

17. The planetary gear mechanism according to claim 15, further comprising an annular member inserted between the first bearing member and the second bearing member.

18. The planetary gear mechanism according to claim 17,
wherein the annular member has an outside diameter larger than one among the first bearing member and the second member having a smaller outside diameter.

19. The planetary gear mechanism according to claim 14,
wherein a first gear part and a second gear part partitioned in the axial direction are arranged coaxially at an outer circumference of the planetary gear.

20. The planetary gear mechanism according to claim 19,
wherein the planetary gear has different outside diameters at the first gear part and the second gear part.

21. The planetary gear mechanism according to claim 20, wherein, in the planetary gear,
the inside diameter of the first inside-diameter part is smaller diameter than the inside diameter of the second inside-diameter part,
the outside diameter of the first gear part is larger diameter than the outside diameter of the second gear part,
the first inside-diameter part and first gear part assume a positional relationship overlapping in the axial direction of the planetary shaft, and
the second inside-diameter part and the second gear part assume a positional relationship overlapping in the axial direction of the planetary shaft.

22. The planetary gear mechanism according to claim 14,
wherein the annual member has an outside diameter that is substantially equal to one among the first bearing member and the second member having a larger outside diameter.

23. The planetary gear mechanism according to claim 14, wherein the outside diameter of the annular member is larger than the inside diameter of the first inside-diameter part of the planetary gear, and is substantially equal to or smaller than the inside diameter of the second inside-diameter part of the planetary gear, and
wherein the inside diameter of the annular member is substantially equal to or larger than the outside diameter of the first outside-diameter part of the planetary shaft, and is smaller than the outside diameter of the second outside-diameter part of the planetary shaft.

24. The planetary gear mechanism according to claim 14, wherein
in a state assembling the planetary gear and the planetary shaft,
the first inside-diameter part of the planetary gear and the first outside-diameter part of the planetary shaft assume a positional relationship overlapping in the axial direction of the planetary shaft, and
the second inside-diameter part of the planetary gear and the second outside-diameter part of the planetary shaft assume a positional relationship overlapping in the axial direction of the planetary shaft.

25. The planetary gear mechanism according to claim 14, wherein the planetary gear has, between the first inside-diameter part and the second inside-diameter part, an inside-diameter stepped part that has an inside diameter which changes to form a step.

26. The planetary gear mechanism according to claim 14,
wherein the planetary shaft has, between the first outside-diameter part and the second outside-diameter part, an outside-diameter stepped part that has an outside diameter which changes to form a step.

27. The planetary gear mechanism according to claim 14,
wherein the inside diameter of the first inside-diameter part of the planetary gear is larger than the outside diameter of the second outside-diameter part of the planetary shaft.

28. The planetary gear mechanism according to claim 16, further comprising an annular member inserted between the first bearing member and the second bearing member.

29. The planetary gear mechanism according to claim 17,
wherein the annual member has an outside diameter that is substantially equal to one among the first bearing member and the second member having a larger outside diameter.

30. The planetary gear mechanism according to claim 17, wherein the outside diameter of the annular member is larger than the inside diameter of the first inside-diameter part of the planetary gear, and is substantially equal to or smaller than the inside diameter of the second inside-diameter part of the planetary gear, and
wherein the inside diameter of the annular member is substantially equal to or larger than the outside diameter of the first outside-diameter part of the planetary shaft, and is smaller than the outside diameter of the second outside-diameter part of the planetary shaft.

31. The planetary gear mechanism according to claim 16, wherein
in a state assembling the planetary gear and the planetary shaft,
the first inside-diameter part of the planetary gear and the first outside-diameter part of the planetary shaft assume a positional relationship overlapping in the axial direction of the planetary shaft, and
the second inside-diameter part of the planetary gear and the second outside-diameter part of the planetary shaft assume a positional relationship overlapping in the axial direction of the planetary shaft.

32. The planetary gear mechanism according to claim 15, wherein the planetary gear has, between the first inside-diameter part and the second inside-diameter part, an inside-diameter stepped part that has an inside diameter which changes to form a step.

33. The planetary gear mechanism according to claim 16,
wherein the planetary shaft has, between the first outside-diameter part and the second outside-diameter part, an outside-diameter stepped part that has an outside diameter which changes to form a step.
